(19) United States
(12) Patent Application Publication
(10) Pub. No.: US 2021/0209976 A1
(43) Pub. Date: Jul. 8, 2021

(54) DISPLAY SWITCHING DEVICE

(71) Applicant: KABUSHIKI KAISHA TOKAI RIKA DENKI SEISAKUSHO, Aichi (JP)

(72) Inventor: Ryuki KANEDA, Aichi (JP)

(73) Assignee: KABUSHIKI KAISHA TOKAI RIKA DENKI SEISAKUSHO, Aichi (JP)

(21) Appl. No.: 17/056,571

(22) PCT Filed: Apr. 23, 2019
(86) PCT No.: PCT/JP2019/017186

§ 371 Date: Nov. 18, 2020

(30) Foreign Application Priority Data
May 24, 2018 (JP) 2018-099702

(51) Int. Cl. G09F 13/32; G02B 5/30; G02B 27/28; G09F 13/34

(52) U.S. Cl. CPC G09F 13/32; G09F 13/34; G02B 27/286; G02B 5/3041

(57) ABSTRACT

A first movable polarizing plate and a second movable polarizing plate are located on a traveling path of light emitted from a light source and having passed through a stable polarizing plate. The first movable polarizing plate is formed with a first display pattern allowing the light to pass through. The second movable polarizing plate is formed with a second display pattern allowing the light to pass through. An actuation mechanism causes a direction of a polarization axis of only one of the first movable polarizing plate and the second movable polarizing plate to be different from a direction of a polarization axis of the stable polarizing plate.

### FIELD

The presently disclosed subject matter relates to a display switching device for switching graphics, characters, and the like to be exhibited.

### BACKGROUND

Japanese Utility Model Publication No. S61-025002 discloses a display switching device using a polarizing plate. The device includes a first light source, a second light source, a first polarizing plate, and a second polarizing plate. The first polarizing plate is disposed on an optical path of the light emitted from the first light source. The second polarizing plate is disposed on an optical path of the light emitted from the second light source. The direction of the polarization axis of the first polarizing plate and the direction of the polarization axis of the second polarizing plate are orthogonal to each other. The device includes a third polarizing plate on which a transparent first display pattern is formed, and a fourth polarizing plate on which a transparent second display pattern is formed. The direction of the polarization axis of the first polarizing plate matches the direction of the polarization axis of the third polarizing plate. The direction of the polarization axis of the second polarizing plate matches the direction of the polarization axis of the fourth polarizing plate. The third polarizing plate and the fourth polarizing plate are disposed on an optical path common to the light emitted from the first light source and the light emitted from the second light source.

The above-described device is configured to display either the first display pattern or the second display pattern by switching the light source to be turned on. Specifically, when the first light source is turned on, the light emitted from the first light source passes through the first polarizing plate, thereby causing the light to have a polarization component parallel to the polarization axes of the second polarizing plate and the fourth polarizing plate. The light passes through the third polarizing plate while being absorbed by the fourth polarizing plate. As a result, the second display pattern formed on the fourth polarizing plate is displayed. When the second light source is turned on, the light emitted from the second light source passes through the second polarizing plate, thereby causing the light to have a polarization component parallel to the polarization axes of the first polarizing plate and the third polarizing plate. The light passes through the fourth polarizing plate while being absorbed by the third polarizing plate. As a result, the first display pattern formed on the third polarizing plate is displayed.

### SUMMARY

### Technical Problem

It is demanded to provide a display switching device capable of selectively displaying a plurality of patterns while using a single light source.

### Solution to Problem

In order to meet the first demand described above, one illustrative aspect of the presently disclosed subject matter provides a display switching device, comprising:
a plurality of movable polarizing plates located on a traveling path of light emitted from a light source and having passed through a stable polarizing plate, and each of which is formed with a display pattern allowing the light to pass through; and
an actuation mechanism configured to cause a direction of a polarization axis of only one of the movable polarizing plates to be different from a direction of a polarization axis of the stable polarizing plate.

According to such a configuration, a plurality of display patterns can be selectively exhibited while using a single light source.

The above display switching device may comprise a support having a rotation axis. The above display switching device may be configured such that:
the movable polarizing plates include a first movable polarizing plate and a second movable polarizing plate supported by the support such that directions of polarization axes thereof are different from each other; and
the actuation mechanism is configured to cause a direction of a polarization axis of one of the first movable polarizing plate and the second movable polarizing plate to be different from the direction of the polarization axis of the stable polarizing plate by rotating the support about the rotation axis.

According to such a configuration, it is possible to realize, with a relatively simple mechanism, a function of selectively exhibiting a plurality of display patterns with light emitted from a single light source.

Alternatively, the above display switching device may be configured such that:
the movable polarizing plates include a first movable polarizing plate, a second movable polarizing plate, and a third movable polarizing plate configured to be rotatable relative to each other about a rotation axis; and
the actuation mechanism includes an actuation member configured to:
   cause a direction of a polarization axis of only one of the first movable polarizing plate and the second movable polarizing plate to be different from the direction of the polarization axis of the stable polarizing plate, with a first actuation; and
   cause a direction of a polarization axis of only one of the second movable polarizing plate and the third movable polarizing plate to be different from the direction of the polarization axis of the stable polarizing plate, with a second actuation that is different from the first actuation.

According to such a configuration, three display patterns can be selectively exhibited with a single light source and a single actuation member.

In this case, the above display switching device may be configured such that:
the movable polarizing plates include a fourth movable polarizing plate configured to be rotatable about the rotation axis, relative to the first movable polarizing plate, the second movable polarizing plate, and the third movable polarizing plate; and
the actuation member is configured to cause only one of the third movable polarizing plate and the fourth movable polarizing plate to be different from the direction of the polarization axis of the stable polarizing plate, with the first actuation and the second actuation.

According to such a configuration, it is possible to selectively exhibit four display patterns with a single light source and a single actuation member.

For example, the above display switching device may be configured such that:
the first actuation is an actuation causing the actuation member to rotate about the rotation axis; and
the second actuation is an actuation causing the actuation member to displace along the rotation axis.

According to such a configuration, the way of exhibition can be changed through different actuations.

The above display switching device may be configured such that the direction of the polarization axis of the one of the movable polarizing plates caused to be different from the direction of the polarization axis of the stable polarizing plate extends along a direction of the polarization axis of the stable polarizing plate.

According to such a configuration, it is possible to reduce the transmission of the light having passed through the stable polarizing plate by the movable polarizing plate on which the display pattern to be exhibited is formed. As a result, a desired display pattern can be clearly exhibited.

As used herein, the term “polarization axis” means an axis extending along a polarization direction that does not allow light to pass through a polarizing plate. The polarization axis intersects a transmission axis extending along a polarization direction that allows light to pass through the polarizing plate. In the case of an absorption-type polarizing plate, the “polarization axis” corresponds to the absorption axis. In the case of a reflection-type polarizing plate, the “polarization axis” corresponds to the reflection axis.

### BRIEF DESCRIPTION OF DRAWINGS

FIG. 1 illustrates a configuration of a display switching device according to a first embodiment.

FIG. 2 illustrates an operation of the display switching device according to the first embodiment.

FIG. 3 illustrates a configuration of a display switching device according to a second embodiment.

FIG. 4 illustrates an operation of the display switching device according to the second embodiment.

FIG. 5 illustrates a configuration of a display switching device according to a third embodiment.

FIG. 6 illustrates an operation of the display switching device according to the third embodiment.

FIG. 7A illustrates a modified configuration of the display switching device.

FIG. 7B illustrates a modified configuration of the display switching device.

### DESCRIPTION OF EMBODIMENTS

Examples of embodiments will be described in detail below with reference to the accompanying drawings. In each of the drawings used in the following description, the scale is appropriately changed in order to make each member have a recognizable size.

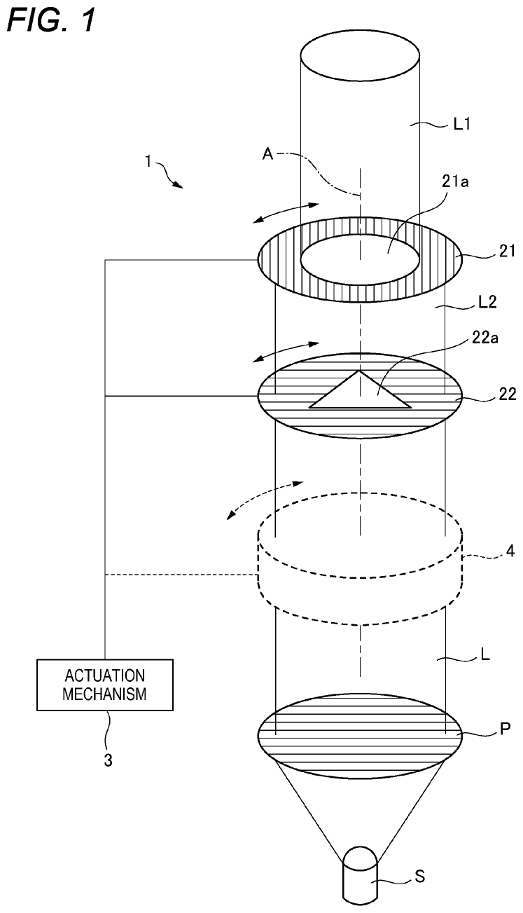

FIG. 1 schematically illustrates a configuration of a display switching device 1 according to a first embodiment. The display switching device 1 includes a first movable polarizing plate 21 and a second movable polarizing plate 22. The first movable polarizing plate 21 and the second movable polarizing plate 22 are configured to be rotatable so that the directions of the polarization axes are changed.

The display switching device 1 is disposed such that the first movable polarizing plate 21 and the second movable polarizing plate 22 are located on a traveling path of light L emitted from a light source S and passed through a stable polarizing plate P. The direction of the polarization axis of the stable polarizing plate P is fixed.

A first display pattern 21a is formed on the first movable polarizing plate 21. A second display pattern 22a is formed on the second movable polarizing plate 22. Each of the first display pattern 21a and the second display pattern 22a is formed as a translucent portion having no polarization property.

The display switching device 1 includes an actuation mechanism 3. The actuation mechanism 3 includes an actuation member adapted to be actuated by a user. Examples of the actuation member may include a dial, a button, and a lever. The actuation mechanism 3 is configured to rotate the first movable polarizing plate 21 and the second movable polarizing plate 22 in accordance with the action of the actuation member. Specifically, the actuation mechanism 3 causes the direction of the polarization axis of only one of the first movable polarizing plate 21 and the second movable polarizing plate 22 to be different from the direction of the polarization axis of the stable polarizing plate P.

In the state illustrated in FIG. 1, the direction of the polarization axis of the second movable polarizing plate 22 matches the direction of the polarization axis of the stable polarizing plate P. Accordingly, the light L having passed through the stable polarizing plate P passes through the second movable polarizing plate 22. On the other hand, the direction of the polarization axis of the first movable polarizing plate 21 and the direction of the polarization axis of the stable polarizing plate P are different from each other. Accordingly, light L2 having passed through the second movable polarizing plate 22 is prevented from transmitting through the first movable polarizing plate 21 except for the portion where the first display pattern 21a is formed. As a result, light L1 having passed through the first display pattern 21a exhibits a shape corresponding to the first display pattern 21a.

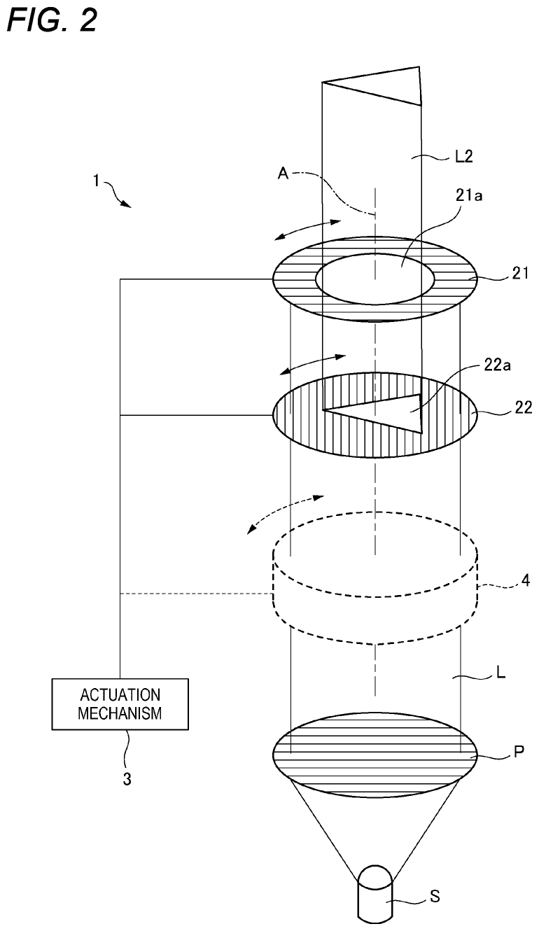

FIG. 2 illustrates a state in which the first movable polarizing plate 21 and the second movable polarizing plate 22 are rotated by the actuation mechanism 3. Specifically, the actuation mechanism 3 causes only the direction of the polarization axis of the second movable polarizing plate 22 to be different from the direction of the polarization axis of the stable polarizing plate P.

Accordingly, the light L having passed through the stable polarizing plate P is prevented from transmitting through the second movable polarizing plate 22 except for the portion where the second display pattern 22a is formed. On the other hand, the direction of the polarization axis of the first movable polarizing plate 21 matches the direction of the polarization axis of the stable polarizing plate P. Accordingly, the light L2 having passed through the second display pattern 22a transmits through the first movable polarizing plate 21. As a result, the light L2 having passed through the second display pattern 22a exhibits a shape corresponding to the second display pattern 22a.

According to such a configuration, a plurality of display patterns can be selectively displayed while using a single light source S. In addition, since the plurality of movable polarizing plates are located on the traveling path of the light L having passed through the stable polarizing plate P, there would be a case where the enlargement of the display switching device 1 in the direction along the polarizing plane can be suppressed.

As illustrated by dashed lines in FIGS. 1 and 2, the display switching device 1 may include a support 4 having a rotation axis A. The support 4 supports the first movable polarizing plate 21 and the second movable polarizing plate 22. Specifically, the first movable polarizing plate 21 and the second movable polarizing plate 22 are supported by the support 4 so that the directions of the polarization axes are different from each other. The first movable polarizing plate 21 and the second movable polarizing plate 22 are overlapped so as to be arranged along the rotation axis A. At least a portion of the support 4 through which the light L passes is formed of a transparent material.

In this example, the actuation mechanism 3 is configured to rotate the support 4 about the rotation axis A in accordance with an actuation of the user. Specifically, the rotation angle of the support 4 is determined such that the direction of the polarization axis of only one of the first movable polarizing plate 21 and the second movable polarizing plate 22 is different from the direction of the polarization axis of the stable polarizing plate P.

In FIG. 1, only the direction of the polarization axis of the first movable polarizing plate 21 is different from the direction of the polarization axis of the stable polarizing plate P. In FIG. 2, only the direction of the polarization axis of the second movable polarizing plate 22 is different from the direction of the polarization axis of the stable polarizing plate P. For example, when the support 4 is rotated clockwise about the rotation axis A, the transition from the state illustrated in FIG. 1 to the state illustrated in FIG. 2 can be made. In this case, when the support 4 is rotated counterclockwise about the rotation axis A, the transition from the state illustrated in FIG. 2 to the state illustrated in FIG. 1 can be made.

According to such a configuration, it is possible to realize, with a relatively simple mechanism, a function of selectively exhibiting a plurality of display patterns with light emitted from a single light source S.

As the actuation member in the actuation mechanism 3, the support 4 may be used. For example, the support 4 may be a knob or a dial adapted to be rotated by a user. In this case, power for actuating the actuation mechanism 3 can be eliminated.

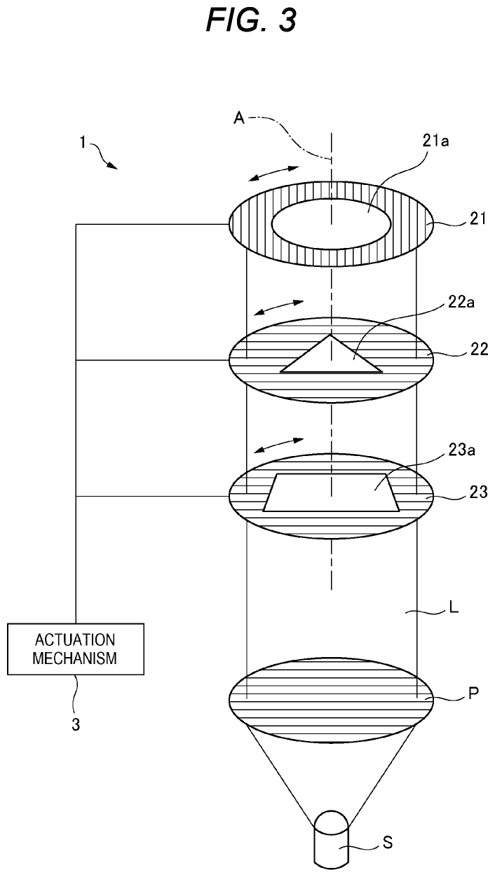

FIG. 3 schematically illustrates a configuration of a display switching device 1 according to a second embodiment. Components common to those in the first embodiment are assigned with the same reference numerals, and repetitive descriptions for those will be omitted.

The display switching device 1 according to the present embodiment includes a third movable polarizing plate 23 in addition to the first movable polarizing plate 21 and the second movable polarizing plate 22. A third display pattern 23a is formed on the third movable polarizing plate 23. The third display pattern 23a is formed as a translucent portion having no polarization property.

The first movable polarizing plate 21, the second movable polarizing plate 22, and the third movable polarizing plate 23 are arranged along the rotation axis A and are configured to be rotatable about the rotation axis A relative to each other. The light L emitted from the light source S and having passed through the stable polarizing plate P travels along the rotation axis A.

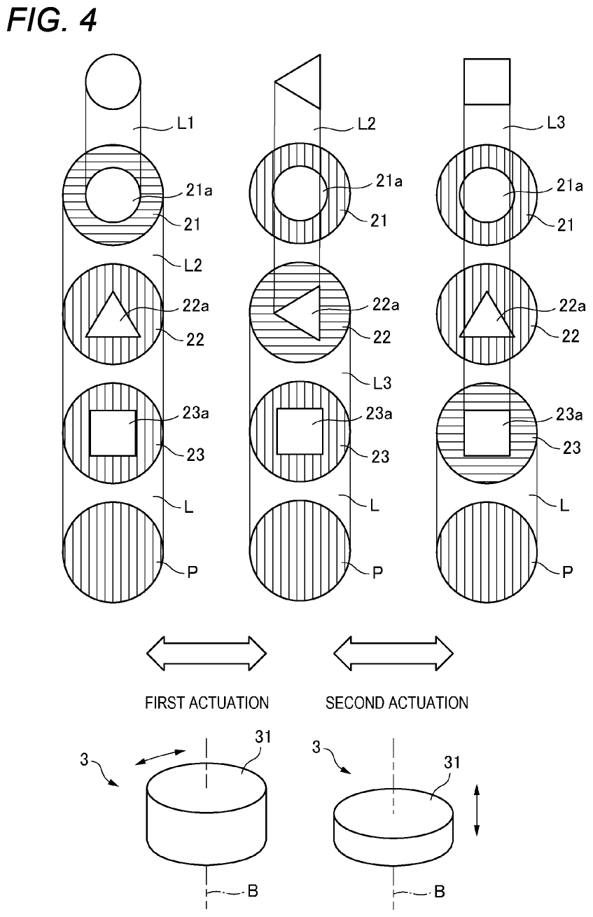

As illustrated in FIG. 4, the actuation mechanism 3 includes an actuation member 31. The actuation member 31 is configured to be capable of performing a first actuation and a second actuation different from each other. In this example, the first actuation is an actuation for rotating the actuation member 31 about a rotation axis B. The second actuation is an actuation of displacing the actuation member 31 along the rotation axis B.

When the first actuation is performed on the actuation member 31, the actuation mechanism 3 causes the direction of the polarization axis of only one of the first movable polarizing plate 21 and the second movable polarizing plate 22 to be different from the direction of the polarization axis of the stable polarizing plate P. In addition, when the second actuation is performed on the actuation member 31, the actuation mechanism 3 causes the direction of the polarization axis of only one of the second movable polarizing plate 22 and the third movable polarizing plate 23 to be different from the direction of the polarization axis of the stable polarizing plate P.

For example, when the actuation member 31 is rotated counterclockwise about the rotation axis B, the direction of the polarization axis of the first movable polarizing plate 21 and the direction of the polarization axis of the stable polarizing plate P are caused to be different from each other, whereas the directions of the polarization axes of the second movable polarizing plate 22 and the third movable polarizing plate 23 are caused to match the directions of the polarization axis of the stable polarizing plate P. Accordingly, the light L emitted from the light source S and having passed through the stable polarizing plate P passes through the third movable polarizing plate 23 and the second movable polarizing plate 22. The light L2 having passed through the second movable polarizing plate 22 is prevented from transmitting by the first movable polarizing plate 21 except for the portion where the first display pattern 21a is formed. As a result, the light L1 having passed through the first display pattern 21a exhibits a shape corresponding to the first display pattern 21a.

In this case, when the actuation member 31 is rotated clockwise about the rotation axis B, the direction of the polarization axis of the second movable polarizing plate 22 and the direction of the polarization axis of the stable polarizing plate P are caused to be different from each other, whereas the directions of the respective polarization axes of the first movable polarizing plate 21 and the third movable polarizing plate 23 are caused to match the direction of the polarization axis of the stable polarizing plate P. Accordingly, the light L emitted from the light source S and having passed through the stable polarizing plate P passes through the third movable polarizing plate 23. The light L3 having passed through the third movable polarizing plate 23 is prevented from transmitting by the second movable polarizing plate 22 except for the portion where the second display pattern 22a is formed. The light L2 having passed through the second display pattern 22a passes through the first movable polarizing plate 21. As a result, the light L2 having passed through the second display pattern 22a exhibits a shape corresponding to the second display pattern 22a.

For example, when the actuation member 31 is displaced downward along the rotation axis B, the direction of the polarization axis of the third movable polarizing plate 23 and the direction of the polarization axis of the stable polarizing plate P are caused to be different from each other, so that the directions of the respective polarization axes of the first movable polarizing plate 21 and the second movable polarizing plate 22 match the direction of the polarization axis of the stable polarizing plate P. Accordingly, the light L emitted from the light source S and having passed through the stable polarizing plate P is prevented from transmitting by the third movable polarizing plate 23 except for the portion where the third display pattern 23a is formed. The light L3 having passed through the third display pattern 23a passes through the second movable polarizing plate 22 and the first movable polarizing plate 21. As a result, the light L3 having passed through the third display pattern 23a exhibits a shape corresponding to the third display pattern 23a.

In this case, when the actuation member 31 is displaced upward along the rotation axis B, it is recovered a state in which only the direction of the polarization axis of the second movable polarizing plate 22 is different from the direction of the polarization axis of the stable polarizing plate P.

According to such a configuration, three display patterns can be selectively exhibited with a single light source S and a single actuation member 31.

The first movable polarizing plate 21, the second movable polarizing plate 22, and the third movable polarizing plate 23 may be supported by the actuation member 31 so that the rotation axis A illustrated in FIG. 3 matches the rotation axis B illustrated in FIG. 4.

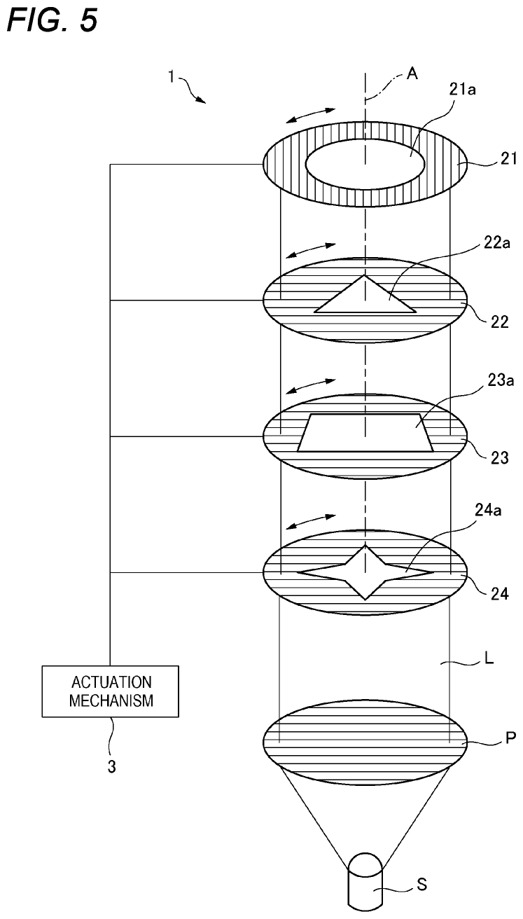

FIG. 5 schematically illustrates a configuration of a display switching device 1 according to a third embodiment. Components common to those in the second embodiment are assigned with the same reference numerals, and repetitive descriptions for those will be omitted.

The display switching device 1 according to the present embodiment includes a fourth movable polarizing plate 24 in addition to the first movable polarizing plate 21, the second movable polarizing plate 22, and the third movable polarizing plate 23. A fourth display pattern 24a is formed on the fourth movable polarizing plate 24. The fourth display pattern 24a is formed as a translucent portion having no polarization property.

The first movable polarizing plate 21, the second movable polarizing plate 22, the third movable polarizing plate 23, and the fourth movable polarizing plate 24 are arranged along the rotation axis A and are configured to be rotatable about the rotation axis A relative to each other. The light L emitted from the light source S and having passed through the stable polarizing plate P travels along the rotation axis A.

In the present embodiment, the actuation member 31 is configured to be capable of performing an actuation in which the first actuation and the second actuation described above are combined. When both the first actuation and the second actuation are performed on the actuation member 31, the actuation mechanism 3 causes the direction of the polarization axis of only one of the third movable polarizing plate 23 and the fourth movable polarizing plate 24 to be different from the direction of the polarization axis of the stable polarizing plate P.

For example, after the actuation member 31 is displaced downward along the rotation axis B as described with reference to FIG. 4, when the actuation member 31 is further rotated clockwise about the rotation axis B, the directions of the polarization axes of the fourth movable polarizing plate 24 and the stable polarizing plate P are caused to be different from each other, so that the directions of the polarization axes of the first movable polarizing plate 21, the second movable polarizing plate 22, and the third movable polarizing plate 23 match the direction of the polarization axis of the stable polarizing plate P. Accordingly, the light L emitted from the light source S and having passed through the stable polarizing plate P is prevented from transmitting by the fourth movable polarizing plate 24 except for the portion where the fourth display pattern 24a is formed. The light L4 having passed through the fourth display pattern 24a passes through the third movable polarizing plate 23, the second movable polarizing plate 22, and the first movable polarizing plate 21. As a result, the light L4 having passed through the fourth display pattern 24a exhibits a shape corresponding to the fourth display pattern 24a.

In this case, when the actuation member 31 is further rotated counterclockwise about the rotation axis B in a state in which the actuation member 31 is displaced downward along the rotation axis B, it is recovered a state in which the direction of the polarization axis of only the third movable polarizing plate 23 is different from the direction of the polarization axis of the stable polarizing plate P.

According to such a configuration, four display patterns can be selectively exhibited with a single light source S and a single actuation member 31.

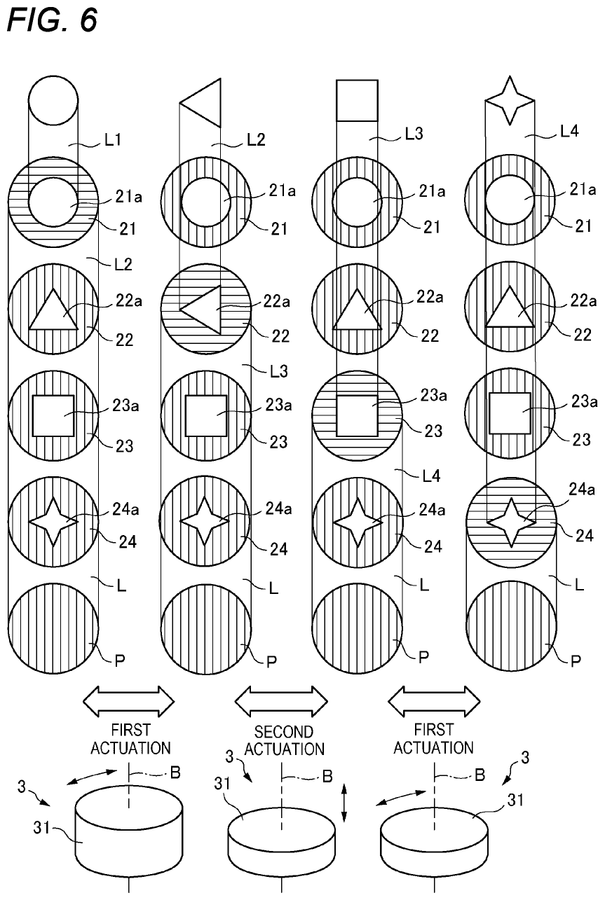

The first movable polarizing plate 21, the second movable polarizing plate 22, the third movable polarizing plate 23, and the fourth movable polarizing plate 24 may be supported by the actuation member 31 so that the rotation axis A illustrated in FIG. 5 matches the rotation axis B illustrated in FIG. 6.

The above-described embodiments are merely examples for facilitating understanding of the presently disclosed subject matter. The configuration according to the above embodiments can be appropriately modified without departing from the gist of the presently disclosed subject matter.

In each of the above embodiments, the direction of the polarization axis of one of the movable polarizing plates that is made different from the direction of the polarization axis of the stable polarizing plate P is orthogonal to the direction of the polarization axis of the stable polarizing plate P. According to such a configuration, it is possible to reduce the transmission of the light L having passed through the stable polarizing plate P by the movable polarizing plate on which the display pattern to be exhibited is formed. As a result, a desired display pattern can be clearly exhibited.

However, the direction of the polarization axis of one of the plurality of movable polarizing plates that is different from the direction of the polarization axis of the stable polarizing plate P may be along a direction orthogonal to the polarization axis of the stable polarizing plate P. The expression “along a direction orthogonal to the polarization axis of the stable polarizing plate P” means that the direction of the polarization axis of one of the plurality of movable polarizing plates is closer to the orthogonal direction than the direction parallel to the polarization axis of the stable polarizing plate P.

In the second embodiment and the third embodiment, the actuation mechanism 3 includes a single actuation member 31 having a knob or dial shape in order to selectively exhibit three or four display patterns. However, as long as the direction of the polarization axis of only one of the three or four movable polarizing plates that are relatively rotatable can be made different from the direction of the polarization axis of the stable polarizing plate P, the number and form of the actuation members can be appropriately determined.

In the third embodiment of the second embodiment, the actuation member 31 is configured to be rotatable (first actuation) about the rotation axis B and to be displaceable (second actuation) along the rotation axis B. According to such a configuration, the way of exhibition can be changed through different actuations. In addition, the area occupied by the actuation member 31 for selectively exhibiting three or four display patterns may be minimized. However, the way of each of the first actuation and the second actuation performed on the actuation member 31 may be appropriately determined according to the specification.

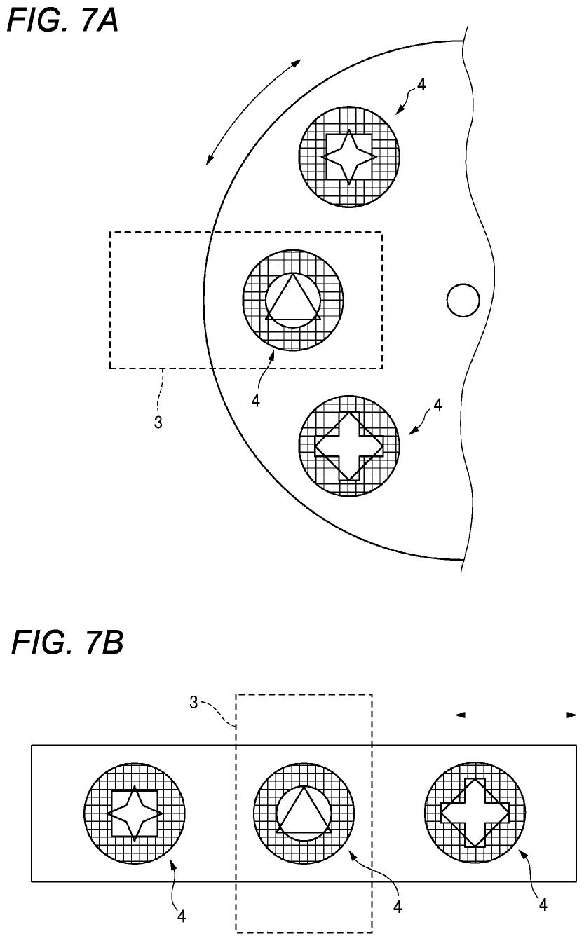

The number of the plurality of movable polarizing plates is not limited to the two, three, and four as described above. For example, as illustrated in FIG. 7A, a configuration may be employed in which a plurality of supports on which two movable polarizing plates are overlappingly supported are held by a rotatable carousel, so that only one of the supports is subjected to the actuation by the actuation mechanism 3 in a region indicated by dashed lines. In this case, by preparing N supports, 2N display patterns can be selectively exhibited. Similarly, as illustrated in FIG. 7B, a configuration may be employed in which a plurality of supports on which two movable polarizing plates are overlappingly supported are held by a slider, so that only one of the supports is subjected to the actuation by the actuation mechanism 3 in a region indicated by dashed lines.

The present application is based on Japanese Patent Application No. 2018-099702 filed on May 24, 2018, the entire contents of which are incorporated herein by reference.

1. A display switching device, comprising:
a plurality of movable polarizing plates located on a traveling path of light emitted from a light source and having passed through a stable polarizing plate, and each of which is formed with a display pattern allowing the light to pass through; and
an actuation mechanism configured to cause a direction of a polarization axis of only one of the movable polarizing plates to be different from a direction of a polarization axis of the stable polarizing plate.

2. The display switching device according to claim 1, comprising:
a support having a rotation axis,
wherein the movable polarizing plates include a first movable polarizing plate and a second movable polarizing plate supported by the support such that directions of polarization axes thereof are different from each other; and
wherein the actuation mechanism is configured to cause a direction of a polarization axis of one of the first movable polarizing plate and the second movable polarizing plate to be different from the direction of the polarization axis of the stable polarizing plate by rotating the support about the rotation axis.

3. The display switching device according to claim 1,
wherein the movable polarizing plates include a first movable polarizing plate, a second movable polarizing plate, and a third movable polarizing plate configured to be rotatable relative to each other about a rotation axis; and
wherein the actuation mechanism includes an actuation member configured to:
cause a direction of a polarization axis of only one of the first movable polarizing plate and the second movable polarizing plate to be different from the direction of the polarization axis of the stable polarizing plate, with a first actuation; and
cause a direction of a polarization axis of only one of the second movable polarizing plate and the third movable polarizing plate to be different from the direction of the polarization axis of the stable polarizing plate, with a second actuation that is different from the first actuation.

4. The display switching device according to claim 3,
wherein the movable polarizing plates include a fourth movable polarizing plate configured to be rotatable about the rotation axis, relative to the first movable polarizing plate, the second movable polarizing plate, and the third movable polarizing plate; and
wherein the actuation member is configured to cause only one of the third movable polarizing plate and the fourth movable polarizing plate to be different from the direction of the polarization axis of the stable polarizing plate, with the first actuation and the second actuation.

5. The display switching device according to claim 3,
wherein the first actuation is an actuation causing the actuation member to rotate about the rotation axis; and
wherein the second actuation is an actuation causing the actuation member to displace along the rotation axis.

6. The display switching device according to claim 1,
wherein the direction of the polarization axis of the one of the movable polarizing plates caused to be different from the direction of the polarization axis of the stable polarizing plate extends along a direction of the polarization axis of the stable polarizing plate.
